(19) United States
(12) Patent Application Publication
(10) Pub. No.: US 2015/0070358 A1
(43) Pub. Date: Mar. 12, 2015

(54) Thotput

(71) Applicant: Marcello Judah Sachs, Boca Raton, FL (US)

(72) Inventor: Marcello Judah Sachs, Boca Raton, FL (US)

(21) Appl. No.: 14/484,121

(22) Filed: Sep. 11, 2014

Related U.S. Application Data
(60) Provisional application No. 61/877,014, filed on Sep. 12, 2013.

(51) Int. Cl. G06T 11/20

(52) U.S. Cl. CPC G06T 11/206
USPC 345/440

(57) ABSTRACT

A new method is presented for modelling domains, the method involving as of yet unacknowledged and uncaptured particular fundamental recursive dynamics in the among part-whole, type-subtype, and type-instance relations. These dynamics are captured using a computational object set forth here as ‘thot’. To engage with and leverage these dynamics given their representation in thot, a set of methods is set forth as ‘thotput’. In capturing and leveraging these fundamental dynamics, the methods increase the verisimilitude of a model, augmenting its power as a representational tool both in computational and human-interface contexts.

### CROSS REFERENCE TO RELATED APPLICATIONS

This application claims priority from U.S. provisional patent application No. 61/877,014 filed Sep. 12, 2013, which is incorporated herein by reference.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

Much of computer programs involve in part an attempt to make models of entities, be they concrete or abstract entities. The power and usefulness of these programs depends in large part on the verisimilitude of these models. These models have always been built within a framework consisting fundamentally of the following basic directed relations:

1) r1: relationship of a whole to its part, where ‘whole’ is interpreted broadly and can mean ‘relation’ (which itself could be the relation of an entity to a property that the entity has)
2) r2: relationship of an instance of a type to that type
3) r3: relationship of a subtype of a type to that type
In the most flexible interpretation, any entity is capable of standing as a relata in either position of any (including any combination) of the above 3 kinds of relations. So for example, a type may have part-whole relations to other entities.

In some cases a hypergraph is used to represent r1, where an edge on the hypergraph is a whole and the nodes on that edge are the parts of that whole. In these cases, the hypergraph is structurally the same as the set of r1 edges it stands for, so we can continue to refer to r1 in its representation as a relation.

Edges representing these relationships of these kinds form 3 respective graphs, and the union of them forms a graph, which we will call gtot. The graph gtot represents both the nature and state of affairs of the domain it models. Let us say that one node n1 on gtot is ascendant of another node n2 if there is a sequence of directed edges leading from n1 to n2 (likewise, we say n2 is descendant of n1).

However, there is a kind of relation that is as fundamental as the above three which is not yet acknowledged, captured, or leveraged in representational frameworks, which limits the usefulness of those frameworks. It cannot be directly represented by the other 3 relation kinds r1, r2, and r3, and thus is not directly represented on gtot.

An entity e1 on gtot often establishes a relationship to an ascendant e2 by virtue of the way in which one of e1's descendants e3 is re-used within a subsystem that is a descendant of e2 but is parallel to e1.

For example, hydrogen establishes a relationship to H20 by virtue of the hydrogen's proton entering into a system of attraction with the electrons of an oxygen atom, this system of attraction being not a proper part of the hydrogen itself but indeed a proper part of the H20. Let us call this dynamic the knot_relation (kr).

Upon acknowledging kr, some useful questions become available, such as:

1) What are the ascendant wholes E2 of e1 whose relations to e1 are grounded by the re-use of a descendant part3 of e1 in a system parallel to e1 itself?
2) What are the ascendant subtypes S2 of s1 whose relations to s1 are grounded by the re-use of a descendant supertype s3 of s1 in a system parallel to s1 itself?

Through recursion and inversion, it is easy to come up with many more questions like these that rely upon the concept of kr.

A question of type 1 would be helpful, for example, when considering the potential effects of a mutation on a part3 on genetic_material2 (where genetic_material2 is ascendant of part3). Since genetic_material2 may be used in an overwhelming number of ascendant (not just parent) systems, we will want to focus our consideration of ascendants on those whose relationship to genetic_material2 is grounded, to an extent, on the re-use of part3 within a subsystem that is parallel to genetic_material2's use of part3. For it is these ascendants to whom the strongest effects of part3's mutation on genetic_material2 will most likely be propagated.

I provide the following precise characterization of the kr:
Let an occurrence of an e1 in e2 be a single path of ascendants between e1 and e2.
kr(e3, e2, e1) iff
when e2 has a relationship established to its ascendant e3,
e1 has an occurrence oc2 in e3 that does not intersect with any of e1's occurrences in e2.
   Let OC1 be the set of occurrences of e1 in e2. In this case, the kr joined OC1 with oc2.

Let a type1-occurrence be an occurrence whose bottom node is of type1. For two different type1-occurrences in an e1, it is possible that they are joined or not. On gtot, it depends on whether the node they end on is the same instance or not of type1. Thus, krs are represented by which type1-occurrences, for each type type1, are joined or not.

Gtot encodes the joining of type-occurrences (and thus kr) in a particular way, using instances that have absolute haecceity. Haecceity is the bare quality of uniqueness that an instance has, making it identical to itself and to no other instance. Absolute haecceity means that the haecceity of an instance is constant throughout all contexts it might find itself in. In other words, if instance1 does not equal instance2, then this is true regardless of which contexts instance1 and instance2 might meet each other in.

Each instance with absolute haecceity is represented on gtot with its own unique node which has a relation of instance to its type. The instance that this node represents cannot change when it is considered within the context of ascendant nodes on gtot.

There are major drawbacks to encoding the joining of type occurrences using instances with absolute haecceity. To begin with, this representation of the joining of type occurrences cannot be normalized.

To clarify what I mean by normalized, let us consider the following example. Let property prop1 of type1 be that two occurrences oc1a and oc1 b of its descendant type type_x1 are joined, and that oc1a is not joined with the occurrence oc1c of type_x1. We can express this as prop1=join(type1, oc1a, oc1 b, type_x1) and not_join(type1, oc1a, oc1c, type_x1). This is a property of type1, and as such should persist when type1 is used in any ascendant wholes or types.

The problem is that even though prop1 persists in ascendant wholes and types, it cannot be normalized and represented within type1 itself. The fact of prop1 has to be re-specified anew in every ascendant. This is because of the way that gtot encodes the joining of type occurrences.

A type is represented by a single node on gtot, though its instances are represented in other nodes, which may be many in number. As such, prop1 can only be represented by an instance i1 of type1. In i1, there is a descendant ix1 that is of type_x1 and lies at the bottom of an occurrence path of type oc1a and oc1 b, and another descendant ix2 of type_x1 (where ix1 does not equal ix2) which is descendant of an occurrence path of type oc1c (when I write ‘occurrence path oc_x of type oc_y’, I mean that if one were to replace every node in the occurrence path oc_x with the type that node is an instance of, I would get oc_y). These separate instances encode the joining and not-joining of occurrence paths that define prop1. Type1 cannot encode on itself, apart from its instances, prop1 because it has only one descendant node representing type_x1. So we see that types cannot encode on themselves properties of the form of prop1.

The only way that types on gtot could potentially encode properties of the form prop1 was if one allowed for multiple nodes to represent the same type (the type itself and not its instances). This approach likely has its own drawbacks, but it won't affect the point we are trying to demonstrate because this approach still encodes properties of the form prop1 using nodes on gtot (which have absolute haecceity). As it turns out, properties of the form prop1 cannot be normalized using a graph in general.

Let us use the term etype_x (and correspondingly etype1, etype2, etc.) to denote either type_x if the approach is taken that allows for the encoding of properties of the form prop1 using only types on gtot, and to alternatively denote an instance of type_x if this approach is not taken.

Let g1 be the subgraph of gtot that encodes etype1 and its descendants as etype1 stands alone (not within an ascendant), including etype1's property prop1. We will show that a graph representing an ascendant of etype1 cannot re-use g1 as a subgraph to represent etype1 (and etype1's property, prop1). An entirely new graph must be furnished to this end.

Suppose there is an etype2 that has property prop2, which we define to be join(etype2, oc2a, oc2b, type_x1). Let us call the graph that represents etype2 as it stands on its own, including prop2 of etype2, to be g2 (analogous to the g1 of etype1). Suppose furthermore that an etype3 and etype4 exist, and that each contains both etype1 and etype2 as descendants, and that in both etype3 and etype4, prop1 and prop2 are still true.

Let an occurrence path ocx be an extension of another occurrence path ocy if ocx is derived by adding a continuous sequence of nodes to the top of ocy.

Then within etype3, there is at least one occurrence path oc3a that is an extension of oc1a, and at least one occurrence path oc3b that is an extension of oc2a. Likewise, within etype4, there is an occurrence path oc4a that is an extension of oc1a, and an occurrence path oc4b that is an extension of oc2a.

If the situation is normalized (etype3 and etype4 both represent etype1 using g1 and etype2 using g2), then a bottom portion of oc3a should be represented by oc1a. Likewise, a bottom portion of oc3b should be represented by oc2a, the bottom portion of oc4a should be represented by oc1a, and the bottom portion of oc4b should be represented by oc2a.

Suppose etype3 has property prop3, which we define to be join(etype3, oc3a, oc3b, type_x1), and etype4 has property prop4, which we define to be notjoin(etype4, oc4a, oc4b, type_x1).

It turns out that prop3 and prop4 cannot be encoded in etype3 and etype4 if they are normalized. For prop3 requires that oc3a and oc3b end on the same node, which in the case of normalization implies that oc1a and oc2a end on identical nodes as well. At the same time, prop4 requires that oc4a and oc4b end on different nodes, which in the case of normalization implies that oc1a and oc2a end on different nodes as well.

With normalization, oc1a always ends on the same node, which we can call n1, and oc2a always ends on the same node, which we can call n2. The identity or non-identity between n1 and n2 must remain unchanged throughout all contexts. And so encoding prop3 and prop4 in a normalized fashion implies a logical contradiction. The only way to encode prop3 and prop4 on gtot is to not allow etype3 and etype4 to re-use g1 and g2; instead they must furnish their own personal graphs to represent etype1 and etype2 as their descendants (along with the properties prop1 and prop2). This lack of the ability to normalize can become prohibitively expensive given a domain with deep hierarchical levels.

Another drawback of current systems is that knot_relation related queries are not available to begin with, and if they were made to be available, they would be prohibitively expensive (as built on current representational frameworks).

Suppose for an etype1 that is descendant of etype2, we desire to find all etypes of the form etype3 where join(etype3, ocx1, ocx2, etype1), where ocx1 runs through etype2 and ocx2 doesnt.

In order to retrieve all such etypes, we would have to retrieve every ascendant etype_x of etype2 and examine the graph representing it and its descendants to see if it involves this kind of join. This will involve a computational expense that grows exponentially with the number of hierarchical levels of ascendants above etype2. For example, if there are 9 levels above etype2, and each element is used in 10 elements at the next level up, we will have to retrieve and examine 1 billion ascendants of etype2.

### BRIEF SUMMARY OF THE INVENTION

Thotput encodes joining of type-occurrences by endowing each entity with its own knotgraph detailing the joining of type-occurrences among its descendants. The exact details of what the knotgraph is and how it is constructed and leveraged is included in the detailed description of this invention. The knotgraph allows the indication of the joining of occurrences to be normalized in the way which proved impossible on gtot. It also allows for efficient knot_relation queries, which does not require the exponentially growing expense of retrieving and examining every ascendant of a particular entity. The invention relies on the identification of the knot_relation as a fundamental relation that should be directly represented, which enables context-dependant haecceity.

A model created with thots is definitively not a graph as whole, since the structure of any group of entities (in particular, the interweavings of their structure) can change depending on the context established by an entity at a higher level. Additional aspects, applications and advantages will become apparent in view of the following description and associated figures.

### BRIEF DESCRIPTION OF THE SEVERAL VIEWS OF THE DRAWINGS

### Note for all Figures

All of the edges on graphs in the figures are directed edges. The edges point from the parent node to the child node. The numbers located on the nodes correspond to thot instances or apg nodes. Certain thot instances may have the same thot at their centers, though they will still receive different reference numbers given that they are distinct thot instances of that thot. Dotted lines and outlines have different meanings in different figures. Refer to the legend in a figure to determine the meaning of a dotted line or outline in that figure.

### FIGURES

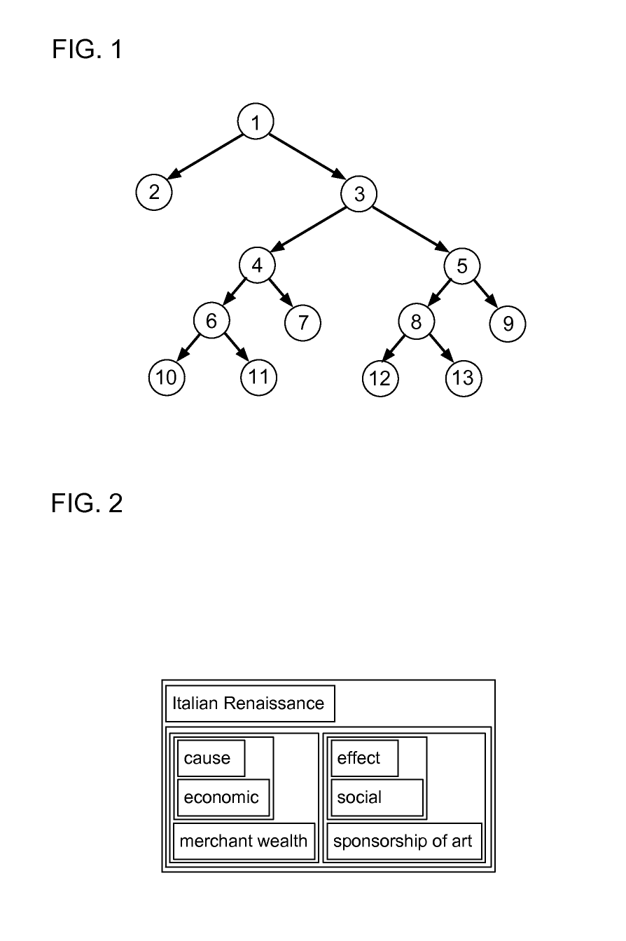

FIG. 1 is a tig with numbered tis. This is the tig that results from the unfurling of t1.d_tig.

FIG. 2 is a view of how an sxg would appear in the application Crosswise if the sxg were representing an apg that represented t1.d_tig.tip_g (which in this case has the same edge structure as t1.d_tig).

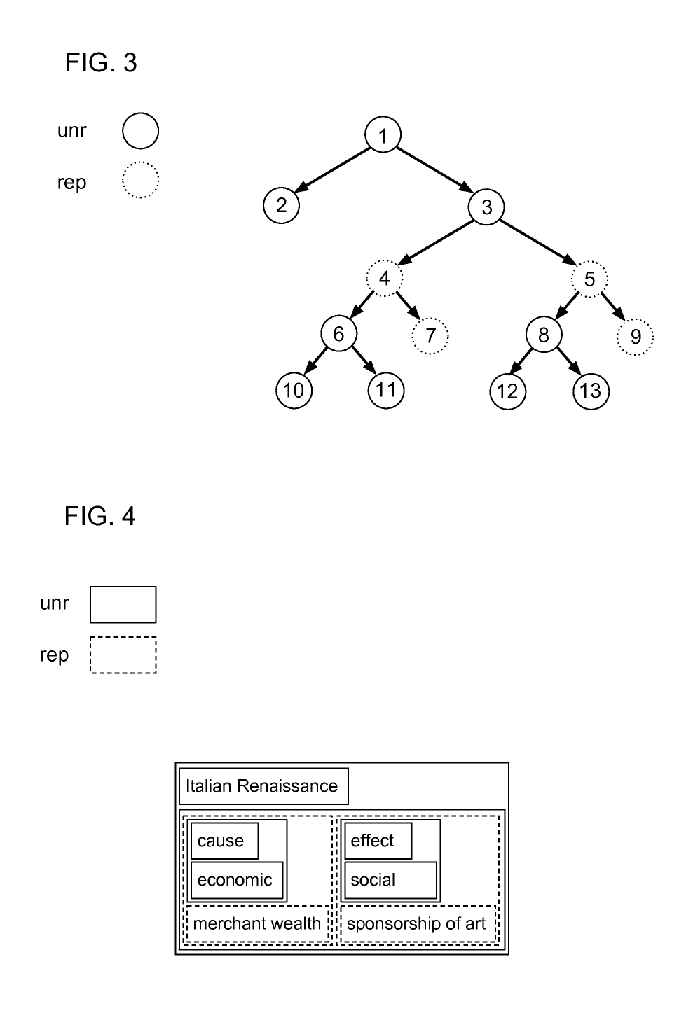

FIG. 3 shows a hinge_indication made on t1.d_tig.

FIG. 4 shows the same hinge_indication, but made on the sxg from FIG. 2.

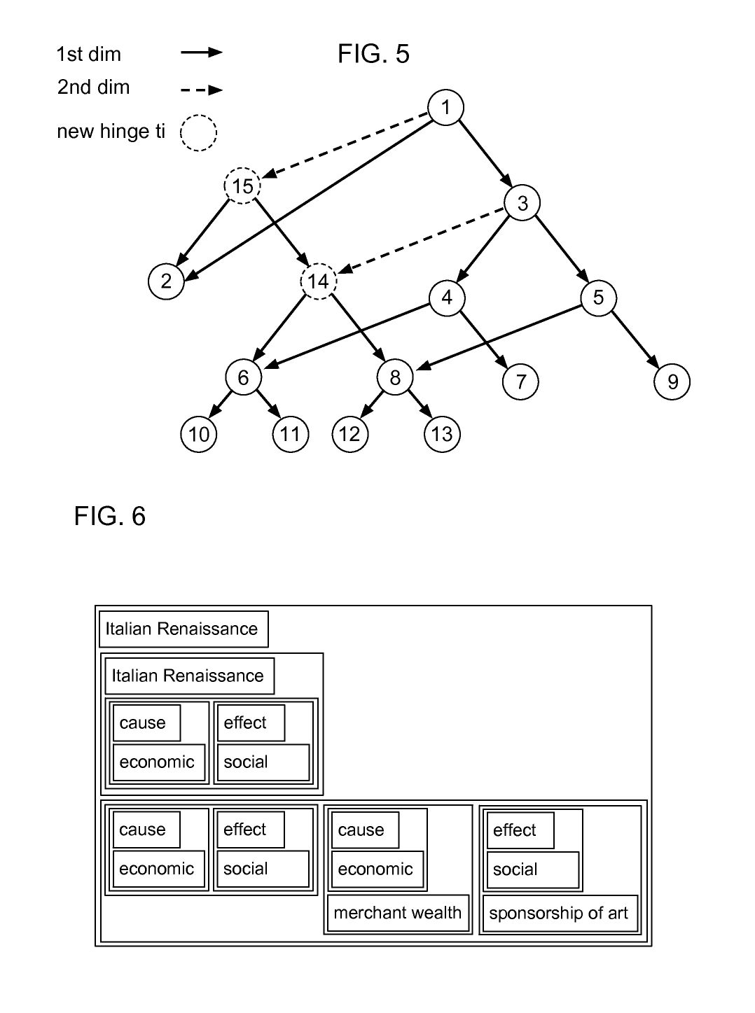

FIG. 5 shows t1.d_tig after it has been modified by a hinge process acting according to the hinge_indication from FIG. 4.

FIG. 6 shows an sxg when it represents an apg that relates to the form t1.d_tig has taken in FIG. 5 through t1.d_tig.tip_g. The new generalizations are visible.

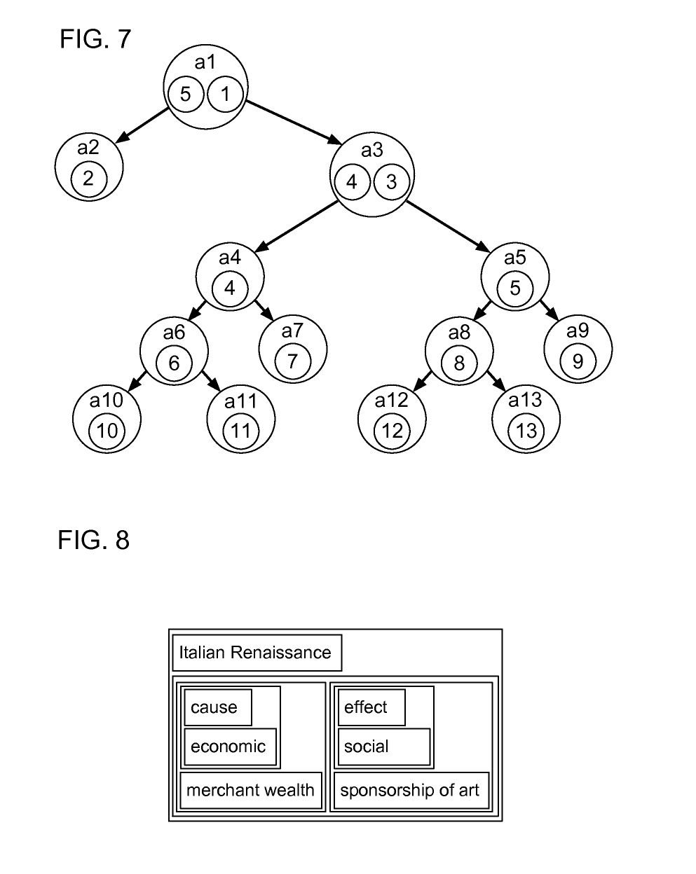

FIG. 7 shows a tilted apg representing the new form of t1.d_tig shown in FIG. 5

FIG. 8 shows an sxg representing the apg in FIG. 7.

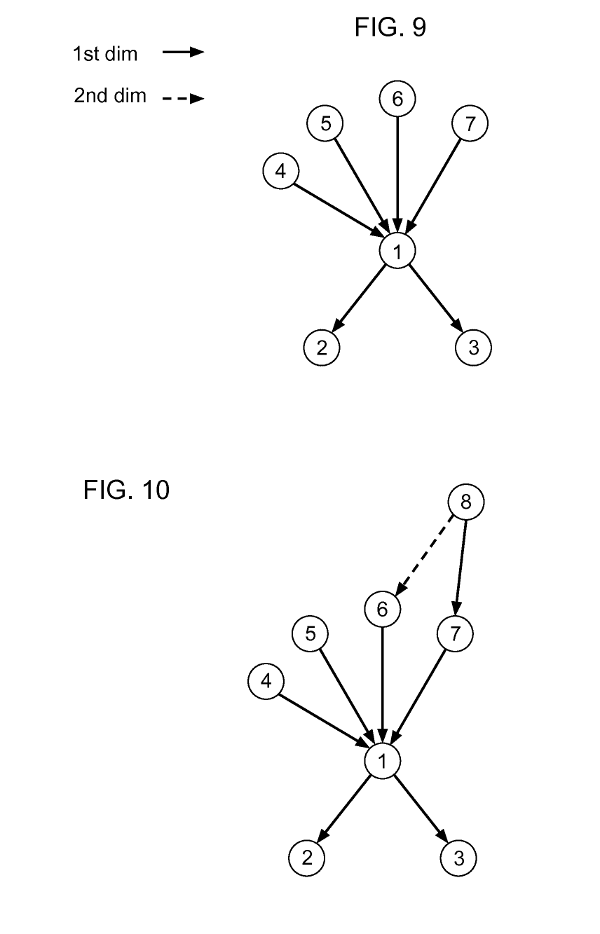

FIG. 9 shows the kg of the thot at the center of the ti numbered ‘6’ in FIG. 1 and in FIG. 5, before the aforementioned hinge process has been enacted.

FIG. 10 shows the kg of the thot at the center of the ti numbered ‘6’ in FIG. 1 and in FIG. 5, after the aforementioned hinge process has been enacted. A knot has been added.

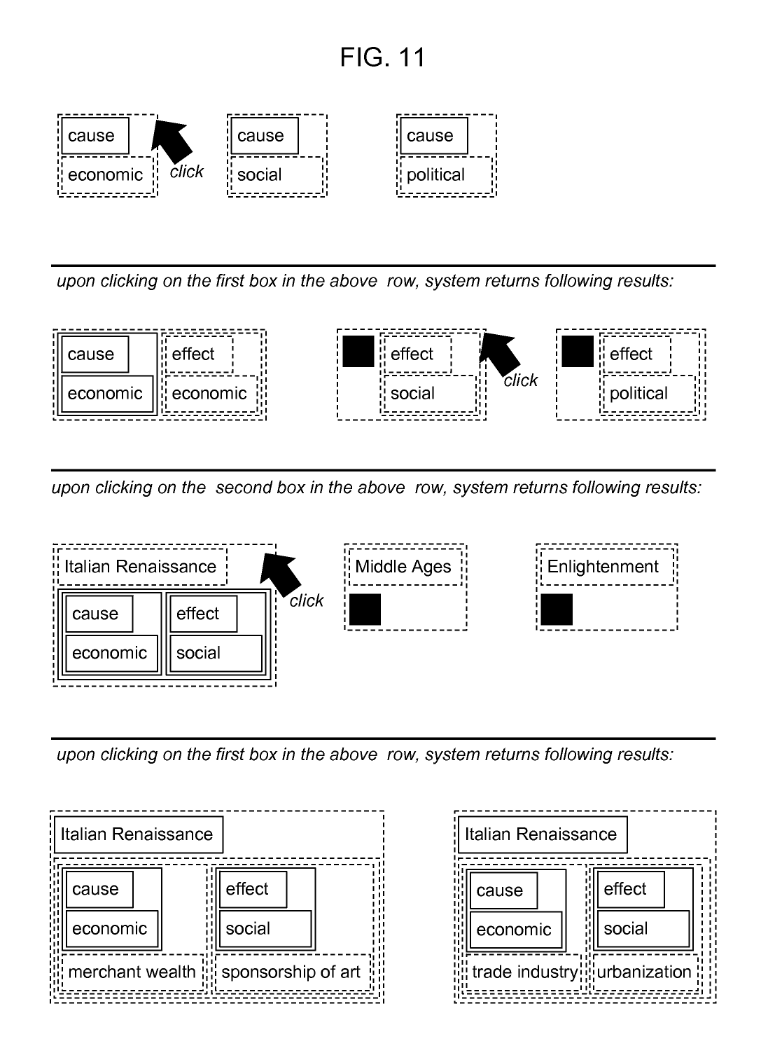

FIG. 11 shows a sequence of specifications accessed by a user in the application Crosswise.

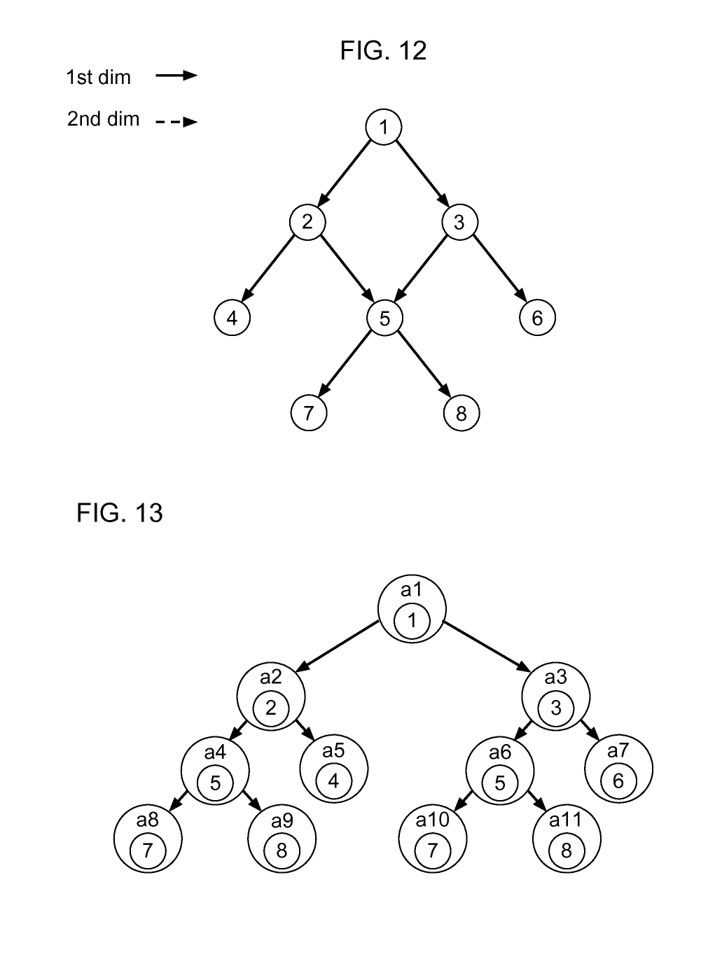

The numberings of tis in FIGS. 12-19 apply to different tis than the tis in FIG. 1 through FIG. 11.

FIG. 12 shows the tig that results from unfurling from t20.d_tig. We can tell that t20 has a non-trivial knot in its dk.

FIG. 13 shows the tilted apg of t20.d_tig. No meaningful tilting has occurred since t20.d_tig has only 1st dimensional edges.

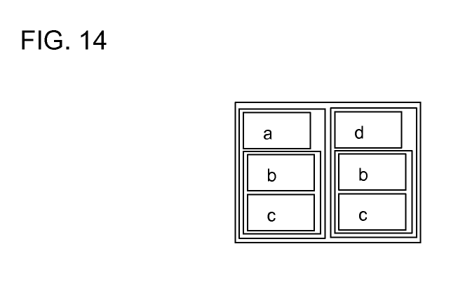

FIG. 14 shows an sxg as it has been made to represent the apg in FIG. 13.

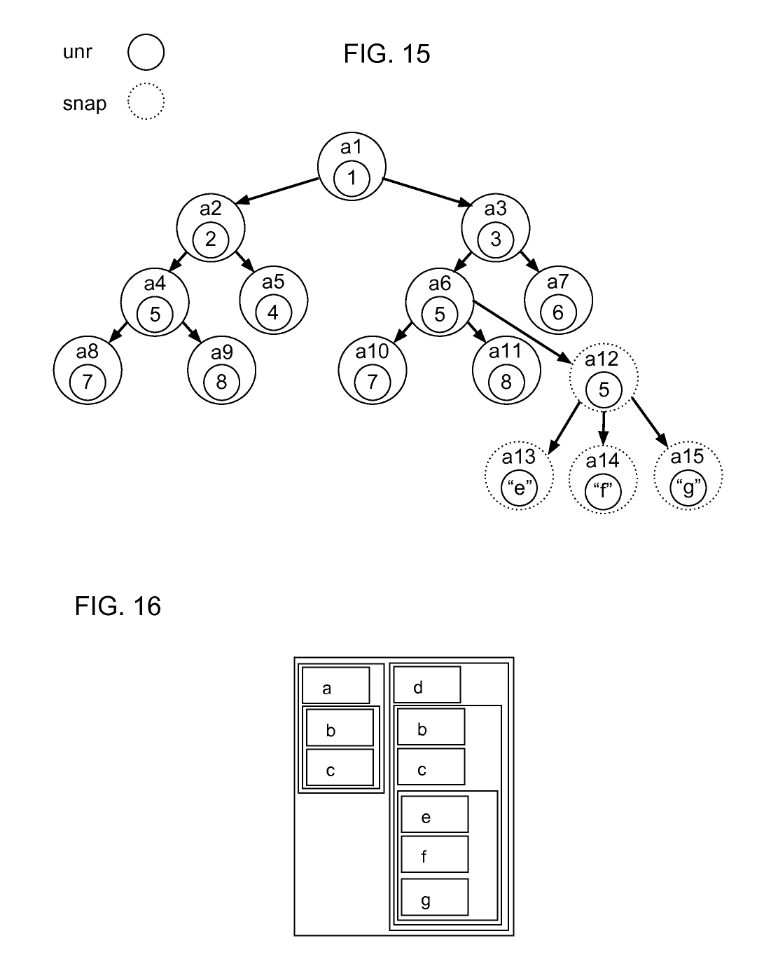

FIG. 15 shows the apg from FIG. 13 after snap_sub nodes have been inserted.

FIG. 16 shows the sxg from FIG. 14 after snap_sub sxs have been inserted (these snap_sub sxs correspond to the snap_sub apg nodes in FIG. 15).

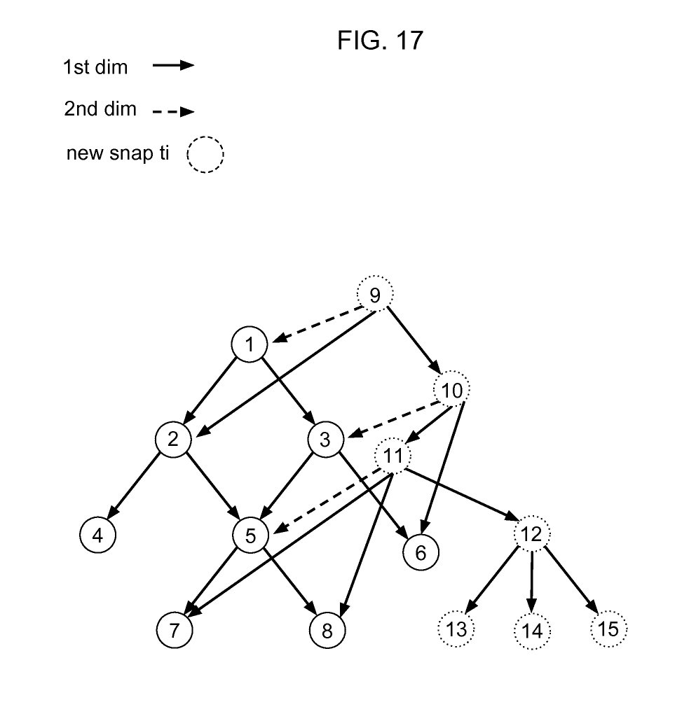

FIG. 17 shows the d_tig of a new thot created as a snap_main_g using the hinge_indication depicted in FIG. 15.

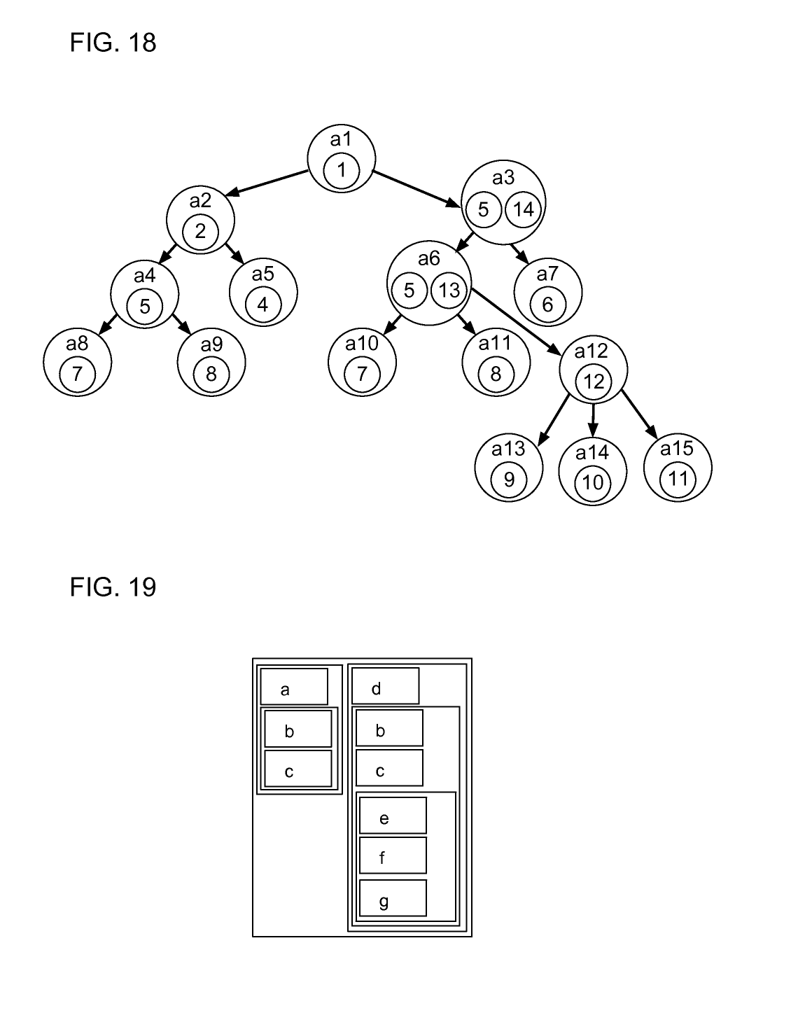

FIG. 18 shows a tilted apg of the tig in FIG. 17.

FIG. 19 shows an sxg made to represent the apg in FIG. 18.

### DETAILED DESCRIPTION OF THE INVENTION

### Introduction

The present invention consists in a system and set of methods for representing, storing, querying, inter-relating, modifying, and viewing information. The name of this system and set of methods is ‘Thotput’. Thotput consists in the invention of a new computational object, called ‘thot’, and in the invention of a system and set of methods for engaging with thot. The present patent application contains the detailed description of Thotput in this Introductory section as well as in the following sections:

### 1. Thot

describes the structure of thot

### 2. Querying

describes system and methods for querying thots and for analyzing the results of those queries

### 3. Hinge

describes system and methods for creating and modifying thots

### 4. Tilt

describes system and methods for managing thots with multi-dimensional edges
5. Crosswise describes a particular application of Thotput that allows people to create and navigate multimedia documents with complex inter-relationships

### 6. Appendix of Program Listings

Although the sections broadly divide the material, the inter-relatedness of the topics requires that the full material corresponding to any one topic may be distributed throughout more than one section, even if that topic is the title of one particular section. In addition to this detailed description of Thotput, this patent application also includes Drawings.

### Relation to Computers

The invention Thotput includes the use of a computer (the physical device) for executing its operations.

More formally, Thotput is a system comprising:
a memory storing computer instructions; and
a processor communicatively coupled to the memory, wherein the processor, responsive to executing the computer instructions, performs operations comprising all the operations described as comprising Thotput in this patent application.

### Applications

Thotput is used for at least the following applications:
communication among groups
record storage and retrieval
learning, education
knowledge management and discovery
data mining
artificial intelligence
theory building
analysis and creative work in the domain of arts, social sciences, humanities, engineering, sciences, or mathematics
applications that involve complex networking of information, such as social networking applications
a domain upon which an entire ecosystem of applications can be built, just like the web is a domain upon which an entire ecosystem of applications is built

Indeed, in any field or domain where representing, storing, querying, inter-relating, modifying, or viewing information occurs on an individual or social basis, thotput is used to technologically enhance the activity in that field or domain.

### Particular Embodiments

This detailed description of the invention includes many particulars for the purposes of illustration. However, anyone of ordinary skill in the art will appreciate that many variations and alterations to the following details are within the scope of the invention. Accordingly, the following embodiments of the invention are set forth without any loss of generality to, and without imposing limitations upon, the claimed invention.

### TERMINOLOGY

The letter t is sometimes used as an abbreviation of thot.
The abbreviation ti is sometimes used as an abbreviation of thot instance.
The abbreviation ‘iff’ stands for ‘if and only if’.

### Algorithm Syntax:

In general, computer instructions are expressed according to the conventions established in the coffeescript programming language (version 1.6.3), as designed by Jeremy Ashkenas. An algorithmic instruction may be expressed in an informal matter when the instruction is of the kind which a person with ordinary skill in the art would easily be able to express more formally in the syntax of a programming language, without requiring an additional creative act or extensive experimentation. The expression of these instructions is comparable to how an instruction would be expressed were it to be written as a step within a flowchart, where one is concerned only with clarity and not with writing something that could in its presented syntactic form be executed directly by a computer. Some algorithms will be included in an appendix found at the end of this description. Algorithms, which are sometimes called functions, are expressed in the following format:

name_of_algorithm: (input_{—}1, input_{—}2, . . . , input_n)->
body of algorithm that details what operations
are to be performed using the inputs
   Often ‘if’ expressions are used of the following form:
   if condition1

set_{—}1 of statements

else

set_{—}2 of statements

These expressions are to be interpreted thusly:
If condition1 is true, then execute set_{—}1 of statements.
If condition1 is not true, then execute set_{—}2 of statements.
When performing operations on lists or sets, the expression
for x in set_{—}1

body_of_for_expression

means that the operations detailed in body_of_for_expression should be executed for each element in set_{—}1 (whether set_{—}1 is a list or a set), and that the name ‘x’ will be used to represent the particular element that is the subject of a particular step in the iteration on set_{—}1 in the body_of_for_expression.
If an expression of the following form is used in an algorithm:

x1=new y

it means ‘create a new object of category y and call it x1’.
The expression:

array1.push x1

means add element x1 to array1, where array1 is an array, a list, or a set.

### Object Property Syntax:

If an object or an entity x1 is associated with another property, value, object, or entity x2 of category y1, then we can reference x2 by saying x1's y1, and we can also reference x2 using the dot notation x1.y1

### Comments:

Any text following a ‘#’ character (pound sign) within the definition of an algorithm is to be taken as a comment related to the algorithm, and not a part of the executable code composing the algorithm.

### Path:

A path on a graph is a sequence of nodes {x1, x2, . . . , xn} and edges {e1, e2, . . . , en−1} such that:

for every pair of nodes (a,b) where a is the ith element and b is

the (i+1)th element:
there is one and only one edge ej that connects a and b

if n is greater than 1:
x1 is involved in only 1 edge, and xn is involved in only 1 edge,
and every other xi is involved in 2 edges

### Subset, Superset

If A and B are sets, then B is a subset of A (and equivalently, A is a superset of B) if and only if the members of B are also members of A.

Thus a member of a set is a particular subset of that set.
Since the relation of a set to a subset is the more general case of a relation between a set and a member, one can choose to generalize concepts described in what follows by substituting references to a membership relation with a reference to a subset relation.

### Parent, Child, Ascendant, Descendant:

In the context of sets:
If set_y is a member of set_x, then we say that set_x is a parent of set_y, and set_y is a child of set_x. If set_x is parent to set_y, or there is some sequence of sets {set1, set2, . . . set_n} such each set in the sequence is parent to the previous set in the sequence, set′ is parent to set_y, and set_n is child to set_x, then we can say that set_x is an ascendant of set_y, and set_y is a descendant of set_x.
In the context of a graph:
If beginning from node_x it is possible to follow a path of nodes and directed edges in the direction each edge is pointing such that the path ends at node_y, then we can say that node_x is ascendant to node_y, and that node_y is descendant to node_x.
If that path consists in only 1 edge, then we can say that node_x is parent to node_y, and that node_y is child to node_x.
In the context of thot:
(Note: d_tig, seed_node, and center will be defined in the section ‘Thot’)
If thot_x.d_tig includes a node that has as its center thot_y, then thot_x is ascendant to thot_y, and thot_y is descendant to thot_x.
If there is an edge on thot_x.d_tig connecting the seed_node to a node with thot_y as its center, then thot_x is parent to thot_y, and thot_y is child to thot_x.

### Tree:

A tree is a directed graph where no node has more than 1 parent

### Tops and Bottoms:

The tops of a graph are the nodes which do not have parents. The bottoms of a graph are the nodes which do not have children. The tops of a set x of nodes existing within graph1 is the set y of nodes in x such that no node in y has a parent in set x according to the edges of graph1. The bottoms of a set x of nodes existing within graph1 is the set y of nodes in x such that no node in x has a child in set y according to the edges of graph1.

The top of a directed edge is the node from which the edge originates and points away from. The bottom of a directed edge is the node that the edge points to. The top is sometimes called the parent node of the edge, and the bottom is sometimes called the child node of the edge.

The top edges of a set of edges is the subset of edges whose top nodes are not the bottom nodes of any other edge in that set. The bottom edges of a set of edges is the subset of edges whose bottom nodes are not the top nodes of any other edge in that set.

If we refer to the top edge of a set of edges, then we mean the only edge in that set which would be a member of the top edges of that set of edges.

If we refer to the bottom edge of a set of edges, then we mean the only edge in that set which would be a member of the bottom edges of that set of edges.

### Section 1: Thot

### Set, Occurrence, Instance

Before we describe a thot, let us begin with preliminary concepts: set, occurrence, and instance. The notions of occurrence and instance developed here are not conventions in computer science, rather they constitute part of what is novel in this invention.

I establish that an occurrence of a set s is defined by a sequence of sets beginning with an ascendant set of s and ending with s, where each set in the sequence is a parent of the previous set in the sequence.

### Suppose:

s1 is a parent of s2
s2 is a parent of s3
s8 is a parent of s7
s7 is a parent of s3

An occurrence of s3 within s1 is defined by the sequence: [s1, s2, s3]. One can consider this sequence as a path, where each element is a node on the path and the relation of parenthood is manifested by directed edges on the path. This path would be called an occurrence path, and it defines this occurrence. We will use the sequence notation to represent these paths. An occurrence of s3 within s8 is defined by the occurrence path: [s8, s7, s3].

I define the instance of a set to be a structure with two components: a) the set which is being instanced, which I will call the center of the instance, and b) the instance signature.

I define the instance signature to be a graph of occurrence paths that represents the joining of a set of occurrences of the instance's center, such that each occurrence path represented in the graph has the same beginning and end. The set of occurrence paths being thus joined may be a singleton, in which case the instance signature has the structure of a path. The edges on the instance graph are directed, and point from a node called the parent or top node to a node called the child or bottom node.

On the graph of the instance signature of a set instance, a node1 is parent to node2 if the set that node1 represents is a parent of the set that node2 represents. One of the nodes on the instance signature represents the center of the instance itself, and is called the seed. The set that a node on the instance graph represents is also called the node's center. Thus the seed of an instance graph for a set_instance_{—}1 is the unique node for which node.center=set_instance_{—}1.center

### Suppose:

s1 is a parent of s2
s2 is a parent of s4
s1 is a parent of s3
s3 is a parent of s4

In this case s4 has two occurrences in s1. One occurrence is defined by the occurrence path: [s1, s2, s4] and the other occurrence is defined by the occurrence path [s1, s3, s4]. If these two occurrences are joined into one instance, then s4 has one set_instance_{—}1 in s1 that has an instance signature composed of the following nodes and edges:

nodes:

n1, n2, n3, n4

node centers:

n1.center=s1

n2.center=s2

n3.center=s3

n4.center=s4

edges:

(parent: n1, child: n2)

(parent: n2, child: n4)

(parent: n1, child: n3)

(parent: n3, child: n4)

If the two occurrences are not joined into one instance, then s4 would have two instances in s1, set_instance_{—}1 and set_instance_{—}2, and their instance signatures would be:

(Note: no two instance signatures share a node. We may for example refer to a n1 in set_instance_{—}1.instance_signature and an n1 in set_instance_{—}2.instance_signature, but we are not referring to the same node. The names given to nodes (i.e. n1, n2, . . . ) merely have representational significance within a particular instance signature, not across them).
set_instance_{—}1 instance signature:

nodes:
n1, n2, n3

node centers:
n1.center=s1
n2.center=s2
n3.center=s4

edges:
(parent: n1, child: n2)
(parent: n2, child: n3)
   set_instance_{—}2 instance signature:

nodes: n1, n2, n3

node centers:
n1.center=s1
n2.center=s3
n3.center=s4

edges:
(parent: n1, child: n2)
(parent: n2, child: n3)

If s1 was represented as a hypergraph, where each set only explicitly knows about its direct parents and direct children, there would be no way to indicate whether the two occurrences of s4 as a grandchild of s1 represented the same instance or whether they represented different instances.

If s1 is represented within a thot t1, which is a kind of set of set instances, then t1 would indicate which occurrences of which descendant sets belong to the same or different instances of that set. The way a thot makes this indication is with its instance graph.

### The Instance Graph

Like a set, a thot t1 can have a set of descendant thots. Furthermore, thots have occurrences within other thots, and instances within other thots. However a thot t1, unlike a set (or hypergraph), possesses an instance graph that is a kind of union of its descendant thots' instance signatures within t1.

Let us call the tig describing t1's descendant thot instances (thot instances that are descendant of t1 when t1 is instanced as a thot instance) t1.d_tig. Every node on this graph represents a thot instance. The center of such a node is the center of the thot instance which it represents, and the union of paths extending between a node and the top of the instance graph represents the instance signature of the thot instance which the node represents.

Let us describe the tig more formally. Let a cp function be an isomorphism between graphs that preserves both parenthood and centers, so that:

if it is the case that:

f1 is a cp function

n1 is parent to n2

f1(n1)=f1(n3)

f1(n2)=f1(n4)

then it must be true that

n3 is parent to n4

n1.center=n3.center

n2.center=n4.center

Let us say that two graphs are cp-isomorphic if there exists a function f1 that is a cp isomorphism and maps nodes from one graph into the other.

Let subgraph1(t1.d_tig, n2) be the subgraph of t1.dtig (t1's instances graph) consisting in the union of paths extending between the top of t1.dtig and the node n2.

Then given a thot t1 with thot instance ti1, for every thot instance ti2 instanced within ti1, t1.d_tig is constructed to include at least one node n2 which has ti2.center at its center such that subgraph(t1.dtig, n2) is cp-isomorphic to the instance signature of ti2 as it is instanced within ti1. In a particular embodiment, which will be chosen for use in examples in the description of this invention, there is exactly one such node n2. Let us call this tig_property1.

Likewise, for every node n3 in t1.d_tig, there is a thot instance ti3 that is instanced within ti1, such that ti3.center=n3.center, and such that subgraph(t1.dtig, n3) is cp-isomorphic to the instance signature of ti3 as it is instanced within ti1. Let us call this tig_property2.

So in total, I define thot to be a triplet of:
A: a body (any kind of document or set of documents); may be empty
B: a set of descendant thots; may be empty
C: an instance graph with nodes referencing itself and descendant thots describing their instances within the thot, such that the instance graph satisfies tig_property1 and tig_property2; this instance graph may be normalized into a knotgraph (to be described below); may be empty

An abbreviation for a thot instance graph is tig (or t1.d_tig for a particular t1). An abbreviation for thot instance is ti.

Since the tig describes the instances of descendant thots within a thot, it is possible to specify whether or not particular descendant occurrences are joined into instances. For a tig belonging to t1, a node n1 with a descendant thot t2 at its center represents an instance of t2 within t1, and the union of paths extending between n1 and the seed specify the instance signature of that instance.

One can choose to allow for the ordering of child thot instances, so that one can specify that a thot instance ti2 is the nth child of thot instance ti1. To do so, one associates the number n as the order property on any edges in any instance graphs that reference ti1.center as parent and ti2.center as child.

### The Knot Graph

A knot on thot t1 is a subgraph of its instance graph such that:
the knot consists only of:
1) the seed node (node representing thot1), called the top of the knot
2) another node on the instance graph, called the bottom of the knot
3) two paths path1 and path2 that each begin at the top and end at the bottom where there are no two nodes n2, n3 such that:
   a) n2 lies on path1 between bottom and top
   b) and n3 lies on path2 between bottom and top
   c) and n2 and n3 have a common ascendant node n4 which is a descendant node of the top, where n4 may lie on path1, or on path2, or on both path1 and path2, or on neither of path1 nor path2

The children of the seed in an instance graph represent (possibly among other things) the bottom of simple knots in that instance graph. They are the cases where there are no nodes except a bottom node and a top node, and so there are no nodes in between bottom and top (implying condition 3 above is true).

The union of all of the knots on a thot's instance graph is its knotgraph, which we abbreviate as kg.

If a thot stores its kg, it will not need to store a copy of its instance graph. It will be able to use its kg at any point to recover its entire instance graph. In this way, the joining of occurrences is encoded in a normalized fashion—a thot re-uses the knotgraphs of its descendants in order to recover the complete instance graph of its descendants.

In one embodiment, one can exclude any knot1 from the kg if the kg already possesses a knot2 such that one of knot1's paths (knot1.path1) is already included on knot2 (knot2.path1), and the other of knot1's paths (knot1.path2) intersects the other of knot2's paths (knot2.path2) at some point that is not the top or bottom of the knots. This leaner kg can still be used to recover an entire instance graph. Let us call this the lean_knot_approach.

The kg of a t1 which we have thus far discussed involves information about thots that instantiate within t1. Let us call this portion of the kg the downknot, or dk for short, since all of the nodes on that graph are descendant of the seed, aside from the seed itself. Let us call the tig that results from unfurling t1.dk the t1.d_tig.

We are going to additionally describe another portion of the kg called the upknot, or uk for short, which for a thot t1 contains information about instances of t1 within other thots. The nodes on the upknot are all ascendant of the seed, except for the seed itself. Thus the only node that the uk and the dk have in common is the seed. While t1.dk represents a subgraph of the t1's instance graph, the upknot does not necessarily represent the subgraph of any one thot's instance graph.

I have included in the appendix an example of an algorithm, called d_tig_unfurl, that can recover a thot's instance graph using its dk and the dks of the thots referenced in the nodes of its dk.

To construct a thot t1's upknot, one can use the algorithm titled ‘construct_uk’, included in the appendix.

The construction of the uk does not have to be done all at once, it can be added to incrementally as t1 gets used within new thots.

The utility of the uk will be detailed in the section ‘Querying’.

If one chooses, one can use the lean_knot approach when constructing dks but not when constructing uks. If the lean_knot approach is used when constructing uks, certain measures have to be taken when using the uk for querying.

### N Dimension Relations

One way in which we can add representational sophistication to thots is to consider that the relations that exist among thot instances occupy more than 1 dimension. In other words, there may be some set of n dimensions such that an edge on a thot instance graph extends in those n dimensions or in some subset of them. These are not spatial dimensions necessarily, but dimensions of thot instances.

In the section ‘Tilt’ we will consider a special case of this option where some thot instance edges occupy one dimension, which we term 1st_dim, and other thot instance edges occupy a second dimension, which we term 2nd_dim. In the ‘Getways’ subsection of the section ‘Crosswise’, we will consider a special case of this option where some thot instance edges may also occupy a 3rd dimension, termed 3rd_dim.

### Section 2: Querying

### Notion of Specification

Within a tig, if ti_{—}1 is ascendant of ti_{—}2, then ti_{—}1 is a specification of ti_{—}2. We can write this as spec(ti_{—}1, ti_{—}2). We conversely say that ti_{—}2 is a generalization of ti_{—}1, and write that as gen(ti_{—}2, ti_{—}1). If we speak of the specifications of a thot t1, then we are referring to the specifications of t1 when it is instanced as a thot instance. If we say that a thot t2 is a specification of a thot t1, we mean that when t2 is instanced as a thot instance it is a specification of a thot instance of t1.

Using Uks to Query Specifications: u-Tig

t1.d_tig references all the thots that have instances which are specified by an instance of t1. A similar object which references all the thots that have instances which are specifications of t1 we will call the t1.u_tig. The u_tig, which is a kind of instance graph, can be retrieved by ‘upfurling’ (unfurl upwards) t1.uk into a graph of thot instances. I have included in the appendix an example of an algorithm for upfurling, titled ‘u_tig_upfurl’. This algorithm is similar to d_tig_unfurl; instead of iterating from parent to child, it iterates from child to parent. And instead of using the nodes from a thots dk, it uses the nodes from a thot's uk.

### Alternate Specifications Given a Current Specification

The ‘u_tig_upfur’ algorithm allows one to get the u_tig of a thot, which allows one to retrieve all the specifications of a thot. We can also retrieve the whole or a portion of the u_tig of a thot given its position as a particular thot instance ti_{—}1 in an existing tig, noting associations between tis of the existing tig (which we will call o_tig) and that portion of the u_tig. We can note these associations by first associating u_tig.seed with ti_{—}1, and then associating any u_tig_ti_x and o_tig_ti_y if u_tig_ti_x.ti_child is associated with o_tig_ti_y.ti_child, and if u_tig_ti_x has the same center as o_tig_ti_y.

Noting these associations allows us to see how possible additional specifications of ti_{—}1 relate to its current specification.

Upon upfurling all or a portion of ti_{—}1.u_tig alongside an o_tig, we may also choose to get more detail about one or more specifications ti_y of ti_{—}1 located on ti_{—}1.u_tig by unfurling the d_tig of the thot referenced by ti_y from the position of ti_y.

To do so, create a seed_ti for ti_y.center.d_tig and associate it with ti_y. This seed_ti is marked as unblown in the context of unfurling ti_y.center.d_tig. Now enact the usual d_tig unfurl algorithm, which will begin with seed_ti as its first unblown ti. Associate a ti_w from this unfurling d_tig with a ti_v from the existing o_tig or u_tig if:

ti_w.center=ti_v.center

and ti_w has a ti parent that is associated with a ti parent of ti_v

If we unfurl other such ti_ys from u_tig, we can also choose to note associations between tis resulting from each of their unfurlings according to the same rule. Upon unfurling such ti_ys and noting the appropriate associations, we are afforded a detailed view of how possible additional specifications of a ti_{—}1 relate to each other and to ti_{—}1s current specification within o_tig.

We can establish a meta instance graph (mig) of all these instance graphs according to the following rules:
1) Create a node of the mig to reference each node of the various tigs.
2) Combine mig_nodes that reference tig_nodes that are associated to one another.
3) Make an mig_node_{—}1 parent to an mig_node_{—}2 if mig_node_{—}1 references a tig_node_{—}1 that is parent to a tig_node_{—}2 referenced by mig_node_{—}2.

We can create various rankings of nodes in the mig according to the following method:

1) Select any number of nodes in mig, we will call this selection ‘heads’.
2) Group the heads into different groups of heads. One useful set of groups of heads would be (in the context of the above example involving the overlay of u_tig specifications onto o_tig) the following:

The first group comprises the mig_node that references the top ti in o_tig (which is the current specification of ti_{—}2). The second group comprises mig_nodes that reference the top tis in specifications of ti_{—}2 that were gotten from ti_{—}2.u_tig and have been unfurled along o_tig (additional possible specifications of ti_{—}2).

We can then analyze or rank mig_nodes according to how many of which types of heads it is descendant to. And if we seek an even more sophisticated analysis or ranking, we can tag or rank mig_nodes by which conditions they satisfy from a set of conditions that are each of condition type a, defined below:

condition_type_a: Any condition that is either of the form expressed below as ‘condition_a’, or is condition_{—}1.
condition_type_b: Any condition that is either of the form expressed below as ‘condition_b’, or is condition_{—}1.
condition_a (mig_node):
mig_node is descendant to z1 number of group g1 heads that satisfy a condition y1 that is of condition type b
   condition_b (mig_head):
mig_head is ascendant to z2 number of mig_nodes satisfying a condition y2 that is of condition type a
   condition_{—}1: trivial condition that every mig_node, head or otherwise, satisfies
   Specific values for the variables z1, z2, g1 are left as options (where z1 and z2 are numbers and g1 is a chosen group of heads).

### Kinds of Specifications

So we have just detailed how to retrieve, analyze and rank additional possible specifications of a ti_{—}2 given its current existence within a tig. Since a ti_{—}2 may have many different additional possible specifications, it can be helpful to prioritize a subset of them that have a special significance. Let us begin with some definitions of particular types of specifications and of particular relationships among specifications:

### Further Specification:

furth_spec ti_{—}3, ti_{—}2, ti_{—}1

iff

spec ti_{—}2, ti_{—}1

spec ti_{—}3, ti_{—}1

spec ti_{—}3, ti_{—}2

We say that ti_{—}3's specification of ti_{—}1 is a further specification of ti_{—}2's specification of ti_{—}1.

### Parallel Specifications:

paral_spec ti_{—}3, ti_{—}2, ti_{—}1

iff

spec ti_{—}2, ti_{—}1

spec ti_{—}3, ti_{—}1

˜(spec ti_{—}3, ti_{—}2)

˜(spec ti_{—}2, ti_{—}3)

We say that ti_{—}2 and ti_{—}3 are parallel specifications of ti_{—}1.

### Join Specification:

join_spec ti_{—}2, ti_{—}1

iff

there exists some set of specifications of ti_{—}1, called spec_set_{—}1,

which has at least 2 members, and the following is true:
for any two elements ti_{—}3, ti_{—}4 in spec_set_{—}1:
   paral_specs ti_{—}3, ti_{—}4, ti_{—}1
for any element ti_{—}5 in spec_set_{—}1:
   furth_spec ti_{—}2, ti_{—}5, ti_{—}1
there is no ti_{—}6 such that
   furth_spec ti_{—}2, ti_{—}6, ti_{—}1
   where for every element ti_{—}7 in spec_set_{—}1,
      furth_spec ti_{—}6, ti_{—}7, ti_{—}1
         We say that ti_{—}2 is a join specification of ti_{—}1.

### Nearness of Specification:

if spec ti_{—}2, ti_{—}1

then

c=number of ti_xs such that furth_spec ti_{—}2, ti_x, ti_{—}1

Nearness(ti_{—}2, ti_{—}1)=1/(c+1)

Broadly speaking, if ti_{—}3's specification of ti_{—}1 is a further specification of ti_{—}2's specification of ti_{—}1, then ti_{—}3's specification is less near. However, if ti_{—}3 is a join_specification of ti_{—}1, then it involves the addition of specifications that are nearer than itself to ti_{—}1 and perhaps even nearer than ti_{—}2 to ti_{—}1.

I refine this concept below, and include some more definitions:

### Direct Further Specification:

direct_furth_spec ti_x, ti_y, ti_w

iff

furth_spec ti_x, ti_y, ti_w

there does not exist a ti_z such that
furth_spec ti_x, ti_z, ti_w
furth_spec ti_z, ti_y, ti_w
   We say that ti_x's specification of ti_y is a direct further specification of ti_y's specification of ti_w.
   if

direct_furth_spec ti_{—}3, ti_{—}2, ti_{—}1

direct_furth_spec ti_{—}4, ti_{—}2, ti_{—}1

join_spec ti_{—}3, ti_{—}1

˜join_spec ti_{—}4, ti_{—}1

then

if ti_{—}1's greatest specification changes from ti_{—}2 to ti_{—}3,

the change will result in a greater increase of nearer current specifications of ti_{—}1

than if ti_{—}1's greatest specification were to change from ti_{—}2 to ti_{—}4

This demonstrates that if we are interested in nearer specifications of ti_{—}1, we should focus on its join_specs. And if we are choosing among specifications of ti_{—}1 that are further specifications of ti_{—}2's specification of ti_{—}1, then we want to focus on a certain group of specifications called bow_specs, defined below.

### Bow Specification:

bow_spec ti_{—}3, ti_{—}2, ti_{—}1

iff

furth_spec ti_{—}3, ti_{—}2, ti_{—}1

join_spec ti_{—}3, ti_{—}1

We say that ti_{—}3 is a bow specification of ti_{—}2's specification of ti_{—}1.
We can also say that ti_{—}3 is a bow_spec of ti_{—}1 as it sits within ti_{—}2.

Finding the bow specifications allow a way of focusing on particular further specifications of a ti_x's specification of ti_y. In addition, they provide a useful way of organizing specifications of a ti_x by grouping them according to which generalizations ti_y, when within ti_x, those specifications are bow specifications of.

More formally:
set_{—}1=all the specifications ti_z of ti_x such that

for some generalization ti_y of ti_x
bow_spec ti_z, ti_x, ti_y
   establish groups within set_{—}1 such that for any particular group1

there is some generalization ti_w of ti_x such that

for all ti_v in group1
bow_spec ti_v, ti_x, ti_w

Upon establishing the importance of bow_specs, let us describe a way to retrieve them. The uk of a thot is particularly suited to this end.

Suppose we begin with a tig that is t1.d_tig. Let us call this o_tig and call its top node, the seed of t1.d_tig, ti_{—}1. If we would like to retrieve the bow_specs of a generalization ti_{—}2 within ti_{—}1:

Upfurl ti_{—}2.center.uk alongside o_tig, noting appropriate associations within an mig.
Do not upfurl the uks of any of the centers of the (non-seed) nodes in ti_{—}2.center.uk, just ti_{—}2.center.uk itself. Let's call the graph resulting from this upfurling upfurled_uk(ti_{—}2)
Let's call the ti_nodes in upfurled_uk(ti_{—}2) that represent the tops of knots in ti_{—}2.center.uk the knot_tops(upfurled_uk(ti_{—}2)).
Then the bow_specs are the tis that satisfy the following formula:

bow_spec(ti_{—}3, ti_{—}1, ti_{—}2)

iff

ti_{—}3 in knot_tops(upfurled_uk(ti_{—}2))

spec ti_{—}3, ti_{—}1

Thus given a generalization ti_{—}2 within ti_{—}1, we can retrieve the appropriate bow_specs by utilizing ti_{—}2.uk. And as for the ti_{—}1, we can group its specifications into bow_spec groups using the uks of each of its generalizations.

If the lean_knot_approach was taken in constructing ti_{—}2.center.uk, then when upfurling upfurled_uk(ti_{—}2), also unfurl the dks (dk_set1) of the centers on the nodes of ti_{—}2.uk (but not the dks on the centers of nodes on dk_set1). Only unfurl the knots of dks in dk_set1 that have at their bottom a node that was already on upfurled_uk(ti_{—}2) before the unfurling of dk_set10. Let everything that is now unfurled stand as upfurled_uk(ti_{—}2).

As for the knot_tops(upfurled_uk(ti_{—}2)) which are not bow_specs, they are useful when exploring the possibilities for creating a new thot.

One way of creating a new thot is to join existing parallel specifications in the following way (which we will call parallel_creative_method):

Unfurl t1.d_tig, where the seed is ti_{—}1. For a particular generalization ti_{—}2 of ti_{—}1, upfurl a portion of its u_tig. Select a ti_{—}3 from ti_{—}2.u_tig that is a parallel specification of ti_{—}1 's specification of ti_{—}2. Create a new thot t4 that has ti_{—}1.center and ti_{—}3.center as child thots, where its d_tig is a graph that, aside from its seed node and its edges from seed node to ti_{—}1 and ti_{—}3, is isomorphic to the union of t1.d_tig and ti_{—}3.d_tig according to a parenthood-preserving isomorphism f1 where node_x.center is always equal to f1(node_x).center.

If we seek to create a thot in this way, it is useful to be able to prioritize which specifications ti_{—}3 of ti_{—}2 we are to consider. As demonstrated earlier, the join_specs of ti_{—}2 have a particular significance in terms of the concept of nearness of specifications. Thus one might prioritize the consideration of the join specifications of ti_{—}2 which are not bow_specs.

Knot_tops(upfurled_uk(ti_{—}2)) are exactly the join specifications of ti_{—}2. So when seeking to create a thot using the above described method, one might act more effectively by retrieving the knot_tops(upfurled_uk(ti_{—}2)) that are not bow_specs and considering each one as the potential ti_{—}3. Indeed, before one has decided which ti_{—}2 she is to use to create the new thot in the above described method, one can more effectively explore the options of which ti_{—}2 to use by considering as potential ti_{—}3s the various (non-bow_spec) knot_tops of the upfurled_uks of the various generalizations of ti_{—}1.

### Section 3: Hinge

### Act of Generalization

Let us consider a thot t1 and its descendant thot instances.

If we select an arbitrary set of its descendants, it is possible that they may all be child thot instances of a ti_{—}2 which is a child thot instance of a thot instance of t1. However, this is not necessarily the case for any such arbitrary set of descendant thot instances of t1.

Here we will describe a process called hinge that can create a new child thot instance (new generalization) of an existing thot t1 using a set of t1's existing descendants (existing generalizations). The new generalization may have at its center an existing thot, but we use the word new because this thot was before not in the center of a child thot of t1.

Creating a new generalization in this way adds information to t1 by placing significance on the set of existing descendants used to create the new generalization. Furthermore, the novel grouping of those descendants may represent new information that is not yet expressed in their extant groupings within t1.

If one is navigating the set of thots by traveling from generalization to specification and vice versa (as in, for example, the application discussed in the section “Crosswise”), then this new generalization provides both a new access point to t1, and a new destination point from t1. If one engages with thot specifications in the manner described in the section “Querying”, then this new generalization will affect that engagement.

The hinge process can operate on the tig through an intermediary graph called the appearance graph, or apg for short. There are at least 3 different options for how the apg can relate to the tig. The way that the apg relates to the tig will affect the manner of the hinge process on the tig. Here are 3 options:

A) The apg is created to be isomorphic to the tig through a parenthood-preserving isomorphism f1. In this case the ti that an appearance graph node (apn) represents is whatever ti was sent by f1 to that apn.
B) The apg is created to be isomorphic to the tip_g (derived from the tig) through a parenthood-preserving isomorphism f1 (tip_g is defined in subsection “A More Granular Hinge Process” below). In this case the tip that an apn represents is whatever tip_x was sent by f1 to that apn. And the ti that an apn represents is tip_x.ti.
C) The apg represents a tilted version of the tig. In this case we may say that the apg is tilted. The construction of a tilted apg is described in the section “Tilt”. Which tis are represented by which apns is detailed in that section.

We shall write apn.top_ti to mean the top ti that an apn represents.

This becomes relevant in cases where an apn represents more than 1 ti (namely, option C). The top ti that an apn represents is the top tig node (ti) within the set of tig nodes that an apn represents. If an apn only represents one ti, then that ti is its top ti.

The hinge process begins with an indication made of which descendant tis are to be included in the new generalization. Let us call this the hinge_indication. For a thot t1, the hinge_indication is made on the apg representing t1.d_tig. After the hinge_indication is made, each apn is of one of the two following types:
1) Hinge_type1: apn represents a ti that we wish to include in the generalization; may say that this apn is ‘unr’.
2) Hinge_type2: apn represents a ti that we wish to not include in the generalization; may say that this apn is ‘rep’.
   FIG. 1 shows a tig before a hinge indication has been made on its representative apg, and FIG. 3 shows the same tig after such a hinge indication has been made.

An unr or rep apn may additionally be termed ‘mixed’ if some of its descendants are rep and some of its descendants are unr. If an apn is mixed, then it represents a ti that we wish to partially include in the generalization.

There are two assumptions we can choose to make that will restrict the possibilities of this indication (let apn_x be any apn):

1. If all the descendants of apn_x are rep, then apn_x must be indicated as rep as well.
2. If apn_x is rep, then all of its descendants must also be indicated as rep.

Our following discussion of hinge will apply to the cases where assumption 1 above is held, though it will apply both to cases where assumption 2 is held and to cases where assumption 2 is not held.

Let us call the generalization that the hinge process makes the hinge_ti.

Let top_unr_apn be the tops of the set of unr apn that are not mixed and are descendant of an apn representing t1.d_tig.seed.
For the definition of tops in the context of a set of nodes, see the “Introduction” section. If every apn is unr, or every apn is rep, then hinge will not create a new generalization. We can express this as hinge_ti=null.

We may choose to hold the assumption about thots that a thot must have more than one direct child thot (under the notion that a whole with one part is equivalent to that part). We will call this assumption_{—}3. If we hold assumption_{—}3, then if top_unr has only 1 element apn_x, we will set the hinge_ti to be apn_x.top_ti itself.

If none of the special cases above apply, then hinge_ti is simply a new ti added to t1.d_tig.

If hinge_ti is not null, it is made a direct ti child of the top of t1.d_tig, and is given as its ti children the elements of top_unr. One must now find or create a thot to place in the center of the hinge_ti. This is accomplished by traversing the tig from the position of hinge_ti to determine what the dk of hinge_ti.center would be. If the identified dk matches one belonging to an existing thot t_z, then one set hinge_ti.center as t_z. Otherwise, a new thot t_w is created, given the identified dk, and hinge_ti.center is set to be t_w. At this point we will need to check for any new knots that have been created on the tig. Traverse the tig to check for knots that should be recorded, and record those knots on the appropriate kgs.

### Recursive Generalization and Instance

We can choose to use the hinge_indication on apg to additionally hinge t1's ti descendants (potentially create new generalizations of t1's ti descendants).

Let hinge_indication(apn_x) be the subset of the hinge_indication which applies to apn_x and its descendants. Let apn_x.hinge_ti be the ti added to t1.d_tig that is a generalization of apn_x.top_ti. Then in the context of using the hinge_indication to hinge t1, we will make use of hinge_indication(apn_x) for every apn_x in the apg to hinge each ti descendant ti_y of t1 (to potentially create each apn_x.hinge_ti).

If new generalizations are created of t1's ti descendants, they will have a special relation of instance among each other, and with t1's new child thot instance (hinge_ti). Thus we will have to modify the method of hinge described previously.

Writ large, the new generalizations will have instances directly within the thot instances which they are new generalizations of as well as directly within the new generalizations of the parent thot instances of the thot instances that they are generalizations of.

The above statement is true in option A of the apg relation to the tig, though it becomes more complicated when dealing with option B and option C. The details of these complications are elaborated in the definition of the algorithms in the appendix.

These new relations of instance will create new sections of parallel specifications and join specifications, and thus new knots. Thus the fact that thots include a notion of instance is useful for the expression of recursive generalizations.

Let us say that the hinge_ti created for an apn_x is apn_x.hinge_ti(hinge_type_{—}1) Then the method for determining the hinge_ti for an apn_x and relating it properly to other tis, including other hinge_tis, is the algorithm titled ‘hinge_fn’ that is included in the index, when hinge_type_{—}1 is used as the input for hinge_type.

### Creating the Unr_g

We will use the name unr_g to denote the subgraph of the tig that consists in the hinge_tis and the edges among them created in the above function when it operates over the entire apg using hinge_type_{—}1 as its input for hinge_type.

Since the above hinge_fn connects a hinge_ti to hinge_ti descendants, we need a method that will allow the hinge_fn to operate its way up the entire apg, never operating on a particular apn_x unless all of apn_x's descendants have already been operated upon themselves. To this end we can use the algorithm titled ‘create_unr_g’, included in the appendix, which creates the unr_g.

FIG. 5 shows a tig for which an unr_g has been created, given the hinge indication in FIG. 3. The fact that edges established between a ti and its hinge_ti are shown to be 2nd dimensional edges will be explained in the section ‘Tilt’. FIG. 9 shows the kg of the thot at the center of the ti numbered ‘6’ in FIG. 1 and FIG. 3, before the unr_g has been created. FIG. 10, on the other hand shows that kg after the hinge process created an unr_g, which resulted in a new knot on that kg, as part of its uk.

### Organizing the Repressed

When creating the unr_g, which is a graph involving everything that was indicated to be included in the new child thot of t1, we can also choose to create a rep_g, which is a graph involving everything we chose to not include in that new child thot instance of t1. A hinge_ti created for the rep_g will be referenced by apn_x.hinge_ti(hinge_type_{—}2). We can create the rep_g using the algorithm titled ‘create_rep_g’, which is included in the appendix.

If one wishes, one can configure the system so that a rep_g is created, but it is not created to have recursive instances within the original thot t1. To enact this configuration, simply change the part of the ‘hinge_fn’ algorithm that reads ‘if hinge_type is not hinge_type3’ so that it reads instead ‘if hinge_type is not hinge_type3 and is not hinge_type2’.

### Creating a New Specification

In our act of generalization that we have termed hinge, while we are indicating portions to be included in the generalization and portions to not be included, we may also (or alternatively) choose to insert new portions that are to be a part of a new specification of the principal generalization (of the unr_g). In the case that no generalization is being made, the unr_g is simply the trivial unr_g, the original tig itself. We call the new specification created of the unr_g the snap_main_g, in the sense that it is being ‘snapped’ onto the unr_g. Thot instances which are to be included in the snap_main_g which are not part of the unr_g are designated snap_sub (hinge_type_{—}3) if they have no unr descendants, and wedge_snap otherwise. These tis are indicated through the insertion of new nodes and edges to the apg. One might associate documents to such a ‘snap’ agp node, which will be the body of the thot found or created to be the center of the ti which will become the referent of the apg node. For a particular apn, we reference this document as apn.body.

FIG. 13 shows an apg that represents the tig in FIG. 12, and FIG. 14 shows the insertion of snap_sub nodes onto that apg. The apg in FIG. 13 relates to the tig in FIG. 12 through the tig's tip_g. As such, the added snap_sub nodes in FIG. 14 are precise to tip_g nodes, not tig nodes (tip_g will be explained in the subsection ‘a more granular hinge process’ below.

One may choose to use a method for creating a generalization involving the snap_sub apns; let us call such a generalization the snap_sub_g. One does not need to create a snap_sub_g in order to create a snap_main_g, but if we wish to create a snap_sub_g, one can use the algorithm titled ‘create_snap_sub_g’, included in the appendix.

To create a snap_main_ti, one can use the algorithm titled ‘snap_main_fn’, included in the appendix. And to create the entire snap_main_g, one can use the algorithm titled ‘create_snap_main_g’ (also in the appendix). If one wants to create any of the unr_g, rep_g, or snap_sub_g in addition to creating a snap_main_g, one should create the snap_main_g last.

FIG. 17 shows the snap_main_g created around the tig from FIG. 12 given the snap_sub nodes added in FIG. 14. The meaning of the fact that some of the edges are 2nd dimensional will be explained in the section ‘Tilt’. Since the snap_sub indications were made on an apg that related to the tig through it's tip_g, so the snap_main_g here is precise to tips in its structure.

### A More Granular Hinge Process

In the course of our engagement with thots it can be useful to deal with them on a more granular basis than that of thot instances. Something that is more precise than a thot instance is a thot instance path node, which we call a tip. A thot instance may have multiple tips, though one tip will only ever correspond to a single ti.

A tip is defined by a thot instance and a path along the instance signature of that thot instance that reaches both the bottom and top of that instance signature. See the Introduction section for the definition of a path in the context of graphs.

The instance signature is a major component of a thot instance, and tips give us a way of breaking that component up into smaller components. The path that goes into defining a tip (along with the ti which defines a tip) is called the tip signature. A tip is similar to the notion of occurrence developed in the section ‘Thot’.

We can construct a graph tip_g of thot instances such that the path extending from a particular node on the tip_g to the top of the tip_g represents a particular tip signature of a tip for the ti referenced by the node. We can construct this graph according to a tig so that there is never more than 1 path from a node to the top, and such that every possible tip of every ti in the tig is represented by exactly one node (which is unique to that tip) in the graph and the path extending up from that node.

This resulting tip_g is a tree (or set of trees, depending on the tig), and provides a useful way for engaging with thots particularly when an application is considered that involves a representation of thots as a set of nested figures, where the set of nested figures forms a tree. One such application is discussed in the section “Crosswise”.

To allow the hinge process to operate on the basis of the tip_g of a tig, create an apg that is isomorphic to that tip_g (option B of possible relations between the apg and tig) and have the hinge process operate on that apg.

An algorithm that one can use to construct the tip_g from a tig is included in the appendix, and is titled ‘tip_g_unfurl’.

### Section 4: Tilt

### Motivation

When engaging with a thot, it may be useful to limit our view of it to certain substructures while still maintaining the hidden presence of the rest of the structure. This is similar to the phenomenon in the human psyche, where a multitude of structures connected to a conscious thought may be hidden from consciousness (at least in explicit form) and yet may maintain a meaningful presence, in the very least influencing how the conscious thought develops and in part determining which other thoughts may subsequently enter consciousness.

The method described herein that permits this dynamic with thot involves the use of thots that have some edges with extension in one dimension (called 1st_dim) and other edges with extension in another dimension (called 2nd_dim). The method translates, or ‘tilts’ the tig into an appearance_graph (which we call apg, or ‘tilted apg’), which can be thought of as a graph of explicit conscious awareness. The appearance_graph is a limited view of the tig, yet maintains associations to the tig.

The user can perform queries with uks on the appearance_graph that utilizes structures in the tig that are not immediately visible in the structure of edges among nodes on the appearance_graph. These queries, and the related rankings and analysis will still be influenced by structures in the tig which are not immediately visible in the structure of edges on the appearance_graph.

An illustrative metaphor of this dynamic could be a physical sculpture consisting of flat planks of wood and steel beams that connect the planks of wood. Suppose that each plank of wood is perfectly flat and completely parallel to the xy plane, and that each steel beam is perfectly straight and that its center maintains the same z coordinate throughout its length. If we stand underneath such a sculpture so that we are looking straight up at it, our view of it has been ‘tilted’ such that:

1) We will only see the flat planks of wood. Since any steel beam
begins atop a plank of wood, all the steel beams will be obscured from our view.
2) Some planks of wood will also be partly or completely obscured from our view, if they are located directly above another plank.
3) Suppose plank1 is located above plank2 and part of plank1 is obscured by plank2. Suppose plank1 has a flank that extends in the xy plane to a position where it is not obscured by plank2. From the perception of the viewer, it may seem that this flank in fact is attached to and extends from plank2, even though it may be extremely distant from it in the z axis and is attached to plank1 instead.
4) Even though we cannot see the steal beams, they still influence the way the planks appear to us. The steel beams are responsible for placing certain planks above others, and as such determine which portions of which planks will be obscured from our view, as well as which portions of which planks will appear to be attached to different planks.
5) The present engagement with the sculpture does not consist in a compression of it. One way of compressing the sculpture would be to cut out the silhouette we see of it from a big piece of flat wood. This cutout would contain the current appearance of the sculpture to us while not containing the sculpture's hidden structure. This compressed state of things could be undesirable. Suppose we would like to place a tarp overhang over the sculpture, but the overhang is designed such that its base can only be fixed to a plank of a certain size, which is much smaller than the size of the silhouette of the sculpture. Suppose that in its non-compressed state, the sculpture has a plank at its top that is obscured from our view yet is the perfect size for fixing the base of the overhang onto. In this case we would desire to keep the sculpture uncompressed, so that we do not forgo the possibility of utilizing certain of its sub structures even though they are obscured from our view.

Thus the dynamic we are describing, in this sculptural metaphor as well as in the below thot algorithm, is not a compression, but merely a tilting of our view, as the hidden structures are not properly removed and can still influence and enhance activity.

### Basic Description of Algorithm

Just as the steel poles in the physical sculpture, which extend in a dimension that is perpendicular to the planks, are not visible to us yet influence the appearance of what is visible to us, thot edges that extend in the 2nd_dim will not be visible in the appearance graph yet will influence the appearance of 1st_dim thot edges in the appearance graph.

Roughly, 1st_dim edge sets will become conflated with another, appearing to be only 1 edge_set, if one of the sets is placed to hover over the other by 2nd_dim edges. We can also choose to introduce a restriction whereby edge sets become conflated only if a similar conflation occurred with their parent edge sets. This is the basic gist, though for the complete description of the process one must examine the actual algorithm expressed below.

There is the question—when thots are created, what determines which edge will be a 1st_dim edge and which edge will be a 2nd_dim edge ? One systematic and meaningful way for there to be a creation of 1st_dim edges and 2nd_dim edges is to allow for a special kind of hinge process that operates like the normal hinge process except that:

1) If a new edge is created in the hinge process between apn_x.top_ti and hinge_ti(apn_x, type_y) where type_y is type_{—}1 or type2 (unr or rep), then this edge will be a 2nd_dim edge.
2) If a new edge is created in the hinge process between apn_x.snap_main_ti and apn_x.top_ti, then this edge will be a 2nd_dim edge (note: this excludes edges established for wedge_snaps).
3) All other edges newly established by the hinge process will be 1st_dim edges.

Let us call this way of creating 2nd_dim edges in the hinge process ‘2nd_dim_method1’.

The restriction on tilt that we can choose to make—where edge sets only become conflated if a similar conflation occurred with parent edge sets, is relevant to cases where the hinge process was enacted on an apg that is relating to a tig through its tip_g or through a tilted version of the tig (tilted apg). This restriction makes it so that the appearance of the tig when it is tilted will depend on thot instance paths.

Although this restriction is necessary for a proper tilting of a thot that has been operated on through a tip_g or a tilted tig (tilted apg) by the hinge process, it does not interfere with the proper tilting of a thot that has been operated on by a hinge process that relates directly to a tig (option A of possible ways of relating the tig to an apg). Thus we include the restriction in the algorithm one can use for tilting, titled ‘unfurl_{—}1 st_dim_tree’, as it can be used in either case. This algorithm is included in the appendix.

FIG. 7 shows an apg which has undergone a tilting process in its representation of the tig from FIG. 5. FIG. 7 does not directly show which tig edges are represented by which apg edges, but it does show which apg nodes represent which tig nodes (apg nodes are drawn around the tig nodes they represent). FIG. 18 likewise shows an apg which been tilted in its representation of the tig from FIG. 17. As the tig in FIG. 17 was created as the result of a create_snap_main_g process that was precise to a tip_g, so the tilted apg in FIG. 18 represents a ti_x that was created as a snap_sub in the position corresponding to its tip specific placement as shown in FIG. 15.

### Section 5: Crosswise

Crosswise is a Thotput application (among the ones already described) for creating multimedia documents with complex inter-relationships. The name “Crosswise” comes from the fact that it affords the user a view of parallel specifications as they intersect, or cross, on a common thot instance.

### Boxes, SXG

The apg of a tig is represented on the screen by a graph called the sxg.

A node on the sxg is called an sx. The sxg takes the form of a set of nested boxes (rectangles), where each sx (node) on the sxg has its own box, and if sx_{—}1 is direct child to sx_{—}2, then the sx_{—}1 box appears directly inside the sx_{—}2 box. FIG. 2 is an example of an sxg as it might appear to a user. FIG. 14 is another such example. In the case of FIG. 14, there are individual tis that are assigned to multiple sxs.

Every box can only have 1 parent, so the sxg is a tree. Thus the sxg only represents the apg of a tig when that apg relates to the tig through the tip_g of that tig or through a tilted version of that tig. The apn (apg node) that an sx represents is termed sx.apn.

If we ever refer to the ti that an sx represents, we mean sx.apn.top_ti. However, an sx may represent more than 1 ti, just as an apn may represent more than 1 ti. Thus if we refer to the tis that an sx represents, we mean sx.apn.tis. If we refer to the thot that an sx represents, we mean sx.apn.top_ti.center. A user can add a new sx to the sxg in ways comprising:

1) by putting a new sx around an existing one
(in one implementation: pressing alt key and clicking on the existing sx)
   2) by putting a new sx within an existing one
(in one implementation: pressing shift key and clicking on the existing sx)

The way that these new sxs get used in the creation or modification of a thot will be discussed in the subsection “Crosswise Hinge” below.

If a thot has multiple instances in the tig, then each instance will be assigned an identifying integer, and this integer will be displayed within a representative sx to indicate which instance of its thot it stands for.

### Navigation

### Bloom

The bloom of a thot t1 is the result of the algorithm ‘bloom’, included in the appendix. If a user clicks on an sx, then the machine identifies the bloom t_x of the t1 residing in sx.apn.top_ti.center. The machine then unfurls t_x onto the page. The unfurled t_x is called the page_thot, and its thot instance is called page_thot.ti The ghost_blooms of t1 are a set of thots resulting from the algorithm ‘ghost_blooms’, also included in the appendix.

### Get or Remove Specs

We can configure crosswise so that when a t2 is unfurled on the page as the result of the bloom function, all the ghost_blooms of t2 are also unfurled onto the page. Each ghost_bloom gets its own set of sxs on the sxg, and within an sx representing a particular ghost_bloom is a set of sxs representing t2 (since t2.d_tig has a representation within the d_tig of a specification of t2). The set of sxs in a ghost_bloom that do not represent t2 or subthots of t2 are given a lighter shade for their borders.

Since t2 is already represented within each of its ghost_blooms, we do not need an independent representation of it on the screen.

If the user clicks on a ghost_bloom t4 of t2 then the machine unfurls t4 onto the screen as a normal bloom and then retrieves and unfurls the ghost_blooms of t4 onto the screen.

If the user clicks on a dark ‘cross out’ button in the right hand corner of one of the ghost_blooms, then the ghost_blooms are removed from the screen so that only one set of sxs representing t2 is left on the page.

We call an sx representing a page_thot (bloomed onto page) ‘real’ and an sx representing a ghost_bloom of a bloomed thot that is not real a ‘ghost’. ‘Ghosts’ are given a lighter border than ‘reals’.

If the user hovers (hovers mouse) over a particular real sx1, then the f_specs of page_thot are retrieved that are bow_specs on any ti_x represented by the sx1. More formally, the set includes any spec ti_x such that bow_spec(ti_x, page_thot.ti, ti_z) where ti_z is in the set sx1.apn.tis. These bow_specs are unfurled onto the page. An sx representing a bowspec and not t2 is ‘ghost’, and correspondingly has a lighter border than real sxs. When the user stops hovering over sx1, those bow_specs are removed. If the user double clicks on the sx1, then the bow_specs are not removed even when the user stops hovering over sx1. Clicking on a bow_spec has the same result as clicking on a ghost_bloom.

If the shift key is pressed while a user hovers over an sx1, then the p_specs of any ti_x that sx1 represents are unfurled onto the page alongside the pagethot. An sx representing a p_spec and not t2 is of type ‘ghost’ and correspondingly has a lighter border. As with bow_specs, if the user stops hovering over sx_{—}1 then its p_specs are removed, however if the user double clicks on sx_{—}1 then its p_specs will remain even after she stops hovering over sx_{—}1.

If a p_spec is clicked on, the machine removes all sxs from the screen and then unfurls just that p_spec, as a real thot, onto the screen. If a p_spec is double-clicked on, it is made to be real and forms a part of the ‘real’ tig. A new snap_main sx is added to be direct parent of the top of the new p_spec and the top sx of the original tig. The unr portion of the tig now has two tops, which will be tied together under the one top of the snap_main_g if the hinge process is enacted (see section ‘Hinge’ for more details).

The various ranking strategies detailed in the ‘Querying’ section of this patent can be used to determine the order in which specs are displayed on the page, as well as the coloring or graphical qualities in general of the sxs and their borders.

FIG. 11 shows a sequence of specifications detailing a potential navigational path a user might take through the domain of thot instances.

### Crosswise Hinge

There is a hinge button, which upon being clicked, tells the machine to save the current contents and structure of the sxg as a thot, and modify any related thots as appropriate. The saving and modification occurs using the hinge process described in the ‘Hinge’ section of this patent application. As this process relies on the indication of apns as unr, rep, and snap_sub, let us describe one way this can be done on the sxg:

Any sxs representing thots that arrived on the page through a bloom are tagged as ‘unr’. If a user presses the repress button in the top right hand corner of an sx, then that sx is marked as ‘rep’ and its appearance is either made to fade, change color, or disappear completely. If shift is pressed when a repress button is clicked on a non-atomic sx, then the sx is rep but no change occurs on its sx descendants. If shift is not pressed when a repress button is clicked on a non-atomic sx, then sx and its descendants become rep.

FIG. 4 shows the sxg from FIG. 2 with a hinge indication; certain sxs have been tagged as ‘rep’.

Any sx_{—}2 that the user herself adds around an existing sx_{—}1 by pressing alt and clicking on sx_{—}1 is tagged as ‘snap_wedge’. Any sx_{—}2 that the user herself adds within an existing sx_{—}1 by pressing shift and clicking on sx_{—}1 is tagged as ‘snap_sub’.

The user can add text, an image, video, link, or any document within a snap_sub sx_{—}1. This document will be the body of the thot that is to be the center of the ti created for sx_{—}1.

When the user enters text into a snap_sub sx_{—}1, a search is performed of existing atomic thots with similar texts. The search results are displayed in boxes immediately below sx_{—}1. If a search_result_{—}1 is selected, sx_{—}1 becomes filled with the text from the search result and sx now represents the ti that the sr represented. If the text typed into sx_{—}1 is similar to the text that forms the body of an atomic thot which is already on the tig and represented in a different sx_{—}2, then the thot gets represented in two different search results—one representing the presently used instance of the thot, and one representing a new instance of the thot (which will have the number 2 displayed next to the text). If the thot appears in n different instances already on the page, then there will correspondingly be n+1 search results for it with the appropriate instance numbers indicated (n search results for each existing instance on the page and 1 to represent a potential new instance on the page).

The hinge_indication made for each sx is taken to be the hinge_indication on the apn that the sx represents.

FIG. 6 shows an sxg that represents an non-tilted apg representing a tig that has undergone a hinge process to create an unr_g. Note that the unr_g is visible; all of the generalizations made in the hinge process are explicit in this sxg. FIG. 8 shows an sxg that represents a tilted apg representing the same tig. In the case of FIG. 8, the generalizations created in the hinge process are not directly visible, though they can affect the results and the ranking of the results returned when the user queries for specs of various types, including parallel specs and bow_specs.

FIG. 16 shows an sxg with snap_sub sxs added. FIG. 19 shows the result of creating a snap_main_g using the snap_sub sxs added in FIG. 16. In FIG. 19, the sxg represents a tilted apg.

### Social—Asps

Crosswise allows for the social creation and navigation of thots using angels and angelships (asps). An angel is a kind of thot that represents a particular user. An asp is a kind of thot that represents an association between a created thot and an angel. An asp has restrictions on the number and kind of its child thots:

it has exactly 1 child thot that is a content thot (not an angel or an asp)

it has exactly 1 child thot that is an angel

it can have any number of child thots that are asps that have the same angel child thot

When a thot_{—}1 is created as the result of a hinge process enacted by user_{—}1, an asp is created to associate the angel representing user_{—}1 with the newly created thot_{—}1. This asp is designated an authorship asp. Its content child thot is thot_{—}1, and its angel subthot is the angel representing user_{—}1.

If a user_{—}1 arrives at a thot t1 that was created by someone else but wants to bookmark or associate themselves with that thot, then the user clicks an asp button which creates an asp that associates the user's angel with t1. This asp is not designated as an authorship asp. Its content subthot is t1, and its angel subthot is the angel representing user_{—}1.

In crosswise one can choose to make the asp button be the same as the hinge button, where clicking this button triggers a hinge process or an asp association process according to whether the user has made any modifications to the pagethot or is merely viewing the thot someone else created in its original form.

Whenever an asp is created for a thot t1, asps with the same angel must also be created for all the descendant thots of t1 (whether they are new or not), except for those descendant thots which already have a parent thot which is an asp having the same angel. All of these asps must be connected according to the rule:

if t1 is a parent thot of t2

and a1 is an asp with content child thot t1

and a2 is an asp with content child thot t2

and a1 has an angel child thot that is the same thot as a2's angel child thot
then a1 must be made a parent thot of a2
   Thus a layer of angelships is created that hovers over all the content thots.

The asps must be created in a particular way so that the instance of their content child thot instances are the same instance of those content thots in the current tig. The instances of the asps must also be connected in a particular way. One can use the algorithm titled ‘conjure_asps’, included in the appendix, to accomplish this:

Asps allow one to have a much richer navigational experience. In crosswise the screen can be divided into two portions—featured angel content (feat_ac) and other angel content (other_ac). The feat_ac is above the other_ac. When a user first logs in, she is the featured angel. Whenever the machine seeks the bloom of content thot t1:
A) all the parent thots of t1 that are asps are collected into asp_set_{—}1
B) the asp in asp_set_{—}1 that has the featured angel as a child thot is designated feat_asp
C) the bloom process is enacted for each asp in asp_set_{—}1
D) the machine displays the bloom thot and ghost_blooms for feat_asp in the feat_ac section
E) the machine displays all the other bloom thots and ghost_blooms in the other_ac section

One can choose to allow for orderings of specifications of a thot instance that are custom to a user. In this case, a user) could indicate that specification1 of ti1 is to be presented as the nth such specification of ti1, while user2 could indicate that specification1 of ti1 is to be presented as the mth such specification of ti1. One can implement this kind of ordering by associating a natural number to edges connecting an asp) to its asp parent asp2, where this number will represent the property of ‘specification order’ of asp2's child content thot in its specification of asp1's child content thot, given an indication made by the particular user associated with those asps.

When displaying thots in the feat_ac section, no asps or angels are shown, though the angels name is displayed at the top of the section.

When displaying thots in the other_ac section, only the top-most asps are shown and their angels' names displayed at their top. An sx corresponding to an asp or angel name has a different color border than the other sxs.

When the logged in user is the featured angel, then her angel name is represented in the feat_ac section simply by the sx displaying the logged in users name (which may also the hinge button and the associate_asp button).

In one embodiment, if the logged in user clicks on another angel's asp_sx, then that angel becomes the featured angel, and her name is displayed alongside the box displaying the logged in users name, which itself becomes faded when it is not the featured angel. If the logged in user then clicks on her own name, a hinge process or asp association process is enacted on the current content in the feat_ac section (whether it's hinge or asp association process depends on whether or not the user has made modifications), and after this the logged in user is restored to being the featured angel.

1. A computer implemented method, thotput, of representing, storing, querying, analyzing and displaying information as thot.

2. The method of claim 1, wherein a thot is represented by the tip_g of its d_tig.

3. The method of claim 1, wherein a thot is represented by a tilted apg.

4. The method of claim 1, wherein one identifies and stores the dk of a thot, associating it explicitly to that thot to avoid having to explicitly associate the thot with a stored version of its entire d_tig.

5. The method of claim 4, wherein one recovers a thot's d_tig from its dk using the unfurl_dtig method.

6. The method of claim 1, wherein the part or all of the u_tig of a thot is used to represent its specifications.

7. The method of claim 1, wherein one identifies and explicitly associates a thot to a stored version of its uk to avoid having to explicitly associate that thot to a stored version of it's entire u_tig.

8. The method of claim 6, wherein the utig for a thot instance ti_x is upfurled along an otig in which ti_x is instanced.

9. The method of claim 6, wherein one selects, ranks, and organizes specifications according to different types of specifications, including:
parallel specifications,
bow specifications,
bloom specifications, and
ghost bloom specifications

10. The method of claim 6, wherein one allows for the creation of a new specification using the parallel_creative_method.

11. The method of claim 1 wherein one is provided the option to group any set of thots, thot instances, tigs, or apgs representing tigs in any way, by user, where a group has a unique defining user, and has in its members the subset of the set of items which have an association to that user.

12. The method of claim 6, where given a set of conditions comprising:
any definition of a type of specification spec_type1 that involves taking into consideration the set X of all existing specifications, and
any selected set U of users,
the option to alter the process for identifying specs of spec_type1 by enacting a set of steps comprising:
for each user u1 in U and each specification x1 in X that is a candidate for being of specification type spec_type1, executing an evaluation of whether or not x1 is of specification type spec_type1 where the evaluation is particular to u1 in that the set X is limited to only those which have associations to u1, and
returning the identified specifications of spec_type1 as organized into groups according to which particular-to-user evaluation it satisfied, where these groups may or may not have members in common.

13. The method of claim 12, wherein one uses angelships to implement this kind of consideration of specification types as precise to particular users.

14. The method of claim 1 wherein one allows for the creation and modification of thots using a process comprising the hinge method acting on the thot, where the hinge_indication may be made on the nodes of an apg representing the thot.

15. The method of claim 14, wherein one allows for recursive instancing of the unr_g and snap_sub_g within otig and snap_main_g.

16. The method of claim 15 wherein one allows for edges to be created in the 2nd_dim according to 2nd_dim_method1.

16. The method of claim 1, wherein one allows for the display of an apg of a thot as a set of nested figures.

17. The method of claim 1, wherein one uses numerals to identify a thot instance if it appears in more than one place, for example in more than one place on an apg.

18. The method of claim 1, wherein the system responds to the selection of a particular figure representing a thot or thot instance in any way by bringing forth and displaying the existing specifications of that thot or thot instance, potentially organized by type of specification as well as by which users are associated to a particular specification.
